(19) United States
(12) Patent Application Publication
(10) Pub. No.: US 2024/0392926 A1
(43) Pub. Date: Nov. 28, 2024

(54) TANK FOR FLAMMABLE LIQUIDS AND GASES

(71) Applicant: SIEMENS MOBILITY GMBH, München (DE)

(72) Inventor: Thomas Gross, Wuppertal (DE)

(21) Appl. No.: 18/694,123

(22) PCT Filed: Aug. 19, 2022
(86) PCT No.: PCT/EP2022/073156

§ 371 Date: Mar. 21, 2024

(30) Foreign Application Priority Data
Sep. 21, 2021 (DE) 10 2021 210 466.5

(51) Int. Cl. F17C 13/04; F17C 13/12

(52) U.S. Cl. CPC F17C 13/04; F17C 13/123; F17C 2201/0152; F17C 2203/0639; F17C 2203/0646; F17C 2203/0673; F17C 2205/013; F17C 2205/0332; F17C 2221/012; F17C 2260/04; F17C 2270/0168

(57) ABSTRACT

A tank for flammable liquids and gases for use as a fuel reservoir of a vehicle, contains a tank container, which is equipped with a plurality of thermal pressure relief valves in the event of potential fire. The tank container is equipped on its outer side with a fire protection lining which is adapted in terms of its contour to an enveloping surface of the tank container.

The invention relates to a tank for flammable liquids and gases for use as a fuel reservoir of a vehicle, comprising a tank container which, for a possible case of fire, is equipped with multiple thermal pressure relief valves.

Vehicles for passenger transport, in particular rail vehicles and buses, which for their energy supply are equipped with tanks for flammable liquids and/or gases are known. By way of example, rail vehicles which are driven with the aid of hydrogen are already in use in passenger transport. This hydrogen is typically arranged in a fuel tank container on a roof side of the vehicle.

Such tanks, which are used as fuel reservoir, are only insufficiently protected against vehicle-specific fire events. In this context, it is known to use what are referred to as thermal pressure relief valves (TPRD: thermal pressure relief device) as tank-internal protection devices for thermal protection of the tank. In this case, the thermal protection to be established is defined for example by applicable standards, such as EC79 or the Pressure Equipment Directive. This protection concept is based on what is referred to as a wood crib fire according to EC79, in which it is established that, in this specific fire application, the tank container will not burst or a pressure reduction is effected by venting the fuel before the tank container bursts.

Greater fire events are not taken into account, such as exposing the tank to a Standard temperature-time curve according to ISO 834-1. Such fire events also cannot be completely ruled out for example in rail vehicles and should possibly be taken into account for vehicle approval.

In order to counteract excessive thermal loading of the tank, it has hitherto been customary in rail vehicles to use purchased tanks and to provide corresponding protective measures on the vehicle side. This includes thermal protection of the bodyshell structure or thermal shielding plates in the region of the tank. Verification in terms of the compliance with the required thermal protection was effected by fire simulation or testing under realistic conditions.

A factor common to the fire protection measures for fuel tanks is that hitherto protection devices which are fundamentally vehicle-specific or derived from the specific fire scenario or measurement fire scenario for, for example, hydrogen tanks, which can differ from vehicle to vehicle, are required.

Proceeding therefrom, the invention is based on the object of further developing a tank of the type mentioned in the introduction in such a way that it has thermal protection which also takes account of greater fire events.

This object is achieved by a tank having the features of claim 1.

Accordingly, the tank described in the introduction is distinguished in that the tank container is equipped, on its outer side, with a fire protection cladding which is adapted in terms of its contour to an enveloping surface of the tank container.

The aforementioned fire protection cladding ensures that the tank for flammable liquids and/or gases itself already has the required protection devices, and therefore greater fire events, as defined in ISO 834-1, are also taken into account. On the vehicle side, thermal protective measures are required at most to a limited extent. Preferably, the tank itself is already equipped with all the protection devices that enable its use in the relevant vehicle.

In one embodiment, the fire protection cladding may be formed from steel and/or aluminum, which are equipped with a fire protection coating or temperature-resistant thermal insulation materials and have a predefined fire resistance. As an alternative thereto, it is also possible for the fire protection cladding to be formed from glass-fiber-reinforced plastics plates, which in turn have a predefined fire resistance.

In this case, the “predefined fire resistance” is measured according to the fire scenario which is intended to be counteracted with the aid of the fire protection cladding. Here, the fire resistance requirements depend on predefined necessary time periods for safe evacuation of people in the vehicle or until arrival of the fire department. Here, criteria to be taken into account, in addition to an integrity criterion “E” (for example according to EN 13501-2), are especially the insulation criterion “I” and possibly the radiation criterion “W” (both according to EN 13501-2).

Here, the use of the fire protection cladding restricts a heat input and/or an input of thermal radiation into the tank for a period of time to be defined, such that the tank does not pass into a critical temperature range, which may lead to it bursting.

Preferably, at least one of the thermal relief valves is integrated into a tank outlet valve of the tank.

The tank container may preferably have a rectangular base and two mutually opposite end sides, wherein a middle part, located between the end sides, of the tank container is free from thermal pressure relief valves and the middle part of the tank container is occupied exclusively by the fire protection cladding. In comparison with the prior art, what are referred to as middle TPRDS which are required there and are typically provided at regular spacings along the tank are thus avoided. It is thus made possible to minimize the number of required TPRDs and the associated pipework thereof and to protect against mechanical influences. The associated pipework for a thermal pressure relief valve typically comprises a meltable pipe to which a gas is applied, the pressure of which is measured to be slightly higher than a pressure inside the tank container.

The fire protection cladding may have an extension at at least one determined position, and one of the thermal pressure relief valves may be arranged at this position.

This position is preferably determined by fire simulation calculations.

In a development of this embodiment, provision may be made for the tank container to have a rectangular base and two mutually opposite end sides, wherein one of the end sides of the tank container is free from pressure relief valves and occupied by a fire protection cladding, a middle part, located between the end sides, of the tank container is occupied by the fire protection cladding and, in the middle part, the one thermal pressure relief valve is arranged in a cutout in the fire protection cladding. In this embodiment of the invention, only one end side of the tank container is equipped with the thermal pressure relief valves, this end side bearing no fire protection cladding. However, a remaining peripheral surface of the tank container is occupied with fire protection cladding, except for the region of the cutout, in which one of the thermal pressure relief valves is arranged. This embodiment is distinguished in that only a comparatively low number of pressure relief valves is required.

As an alternative to the embodiment with a rectangular base, provision may also be made for the base of the tank container to be trapezoidal, specifically while retaining the further features of the invention, in particular the arrangement of the fire protection cladding and of the thermal pressure relief valves.

The tank container may be of multipart design and have a number of tank cylinders of identical length which are arranged parallel to one another and each of the end sides of which are arranged in a common plane.

Each of these tank cylinders can then be equipped with thermal pressure relief valves in the manner explained above in the description of the tank.

Exemplary embodiments of the invention will be explained in more detail below with reference to the drawings, in which:

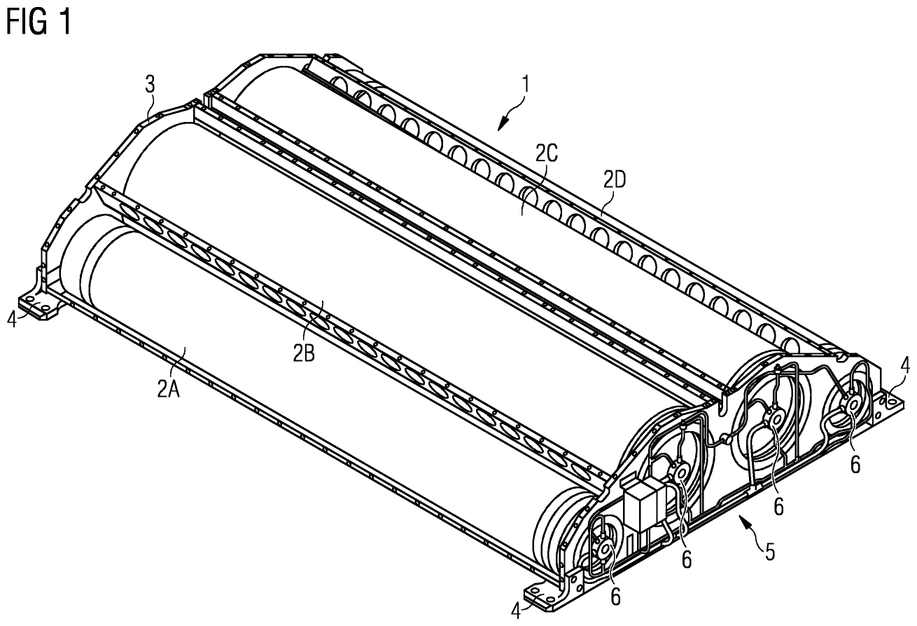

FIG. 1 shows a schematic, perspective view of a tank container without cladding,

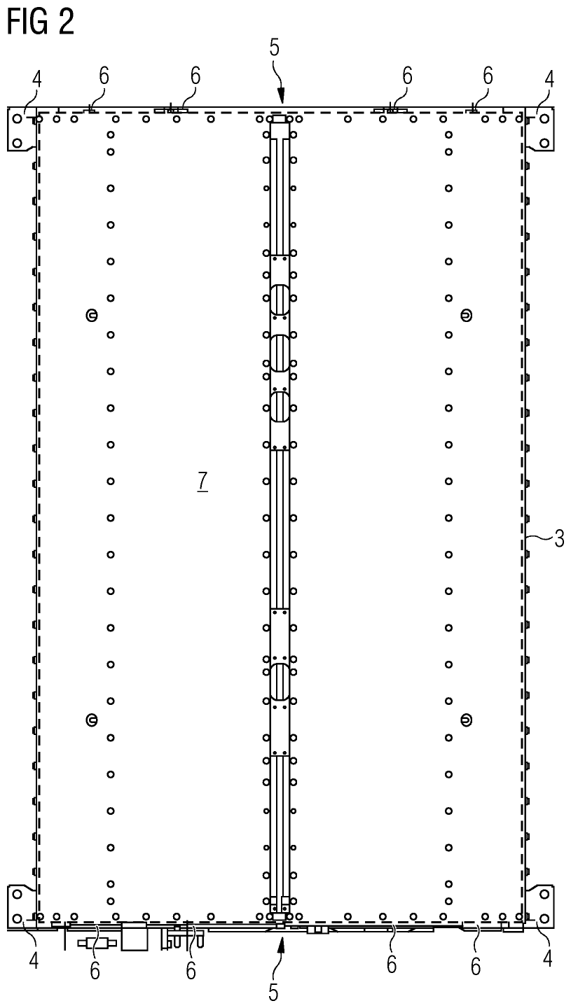

FIG. 2 shows a schematic plan view of a tank for flammable liquids or gases in a first embodiment, and

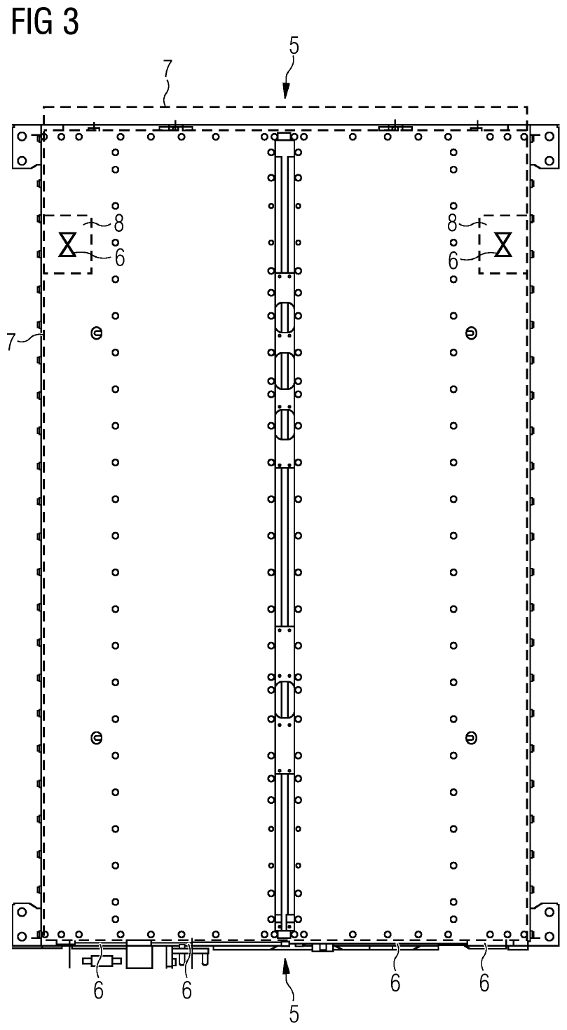

FIG. 3 shows a schematic plan view of a tank for flammable liquids or gases in a second embodiment.

FIG. 1 shows a tank container 1 which, in the illustrated exemplary embodiment, is constructed from four tank cylinders 2A, 2B, 2C, 2D arranged parallel to one another.

In this case, the two inner tank cylinders 2B, 2C have a greater diameter than the outer tank cylinders 2A, 2D.

The tank cylinders 2A, 2B, 2C, 2D are mounted in a tank rack 3, such that the tank rack 3 serves as a carrying frame for the tank cylinders 2A, 2B, 2C, 2D.

The tank container 1 has a rectangular base. At respective corners of this base, the tank rack 3 is equipped with retaining tabs 4 which allow the tank rack 3 to be, for example, screw-fastened to a roof of a vehicle, in particular rail vehicle.

The tank container 1 has two mutually opposite end sides 5 which are each defined by the end sides, lying in a common plane, of the tank cylinders 2A, 2B, 2C, 2D. At one end side 5 of the tank container 1, the end sides of the tank cylinders 2A, 2B, 2C, 2D are equipped with outlet valves 6.

Thermal relief valves (TPRD) are integrated into the tank outlet valves 6.

FIG. 2 shows a plan view of a tank for flammable liquids and/or gases which is equipped with the tank container 1 for use as a fuel reservoir of a vehicle. It is apparent that that part of the tank container 1 which is located between the end sides 5 is equipped from the outside with a fire protection cladding 7. The fire protection cladding 7 may be fastened to the tank rack 3 for example by means of screw, rivet or welded connections. The fire protection cladding 7 may be formed from steel or aluminum plates which are equipped with a fire protection coating or temperature-resistant thermal materials and have a predefined fire resistance. As an alternative thereto, it is possible for the fire protection cladding to be formed from glass-fiber-reinforced plastics plates which have a predefined fire resistance. The manner in which a respective fire resistance and the used thermal insulation materials should be provided is dependent on for example the period of time for which, and in which fire scenario, they are intended to prevent bursting of the tank 1.

A bottom side of the tank 1 facing a vehicle roof is also equipped with the fire protection cladding 7. This measure can be adopted merely as required, in order to ensure fire protection properties to be achieved.

In the embodiment according to FIG. 2, both end sides 5 are equipped with tank outlet valves 6, into which thermal pressure development valves are integrated. In this exemplary embodiment, it is possible to dispense with any thermal pressure relief valves in the region of the tank 1 between the end sides 5, these valves being required in the prior art. In the example, a total of eight thermal pressure development valves are required.

FIG. 3 shows a further exemplary embodiment for a tank for flammable liquids and gases for use as a fuel reservoir of a vehicle, said tank differing from the one in FIG. 2 solely by the positioning of the fire protection cladding 7 and of some of the thermal pressure relief valves. The tank container 1 corresponds to the one which has been explained on the basis of FIG. 1. In the embodiment according to FIG. 3, only one of the two end sides 5 is equipped with thermal pressure relief valves, i.e. there are four thermal pressure relief valves on this end side 5, one for each of the tank cylinders 2A, 2B, 2C, 2D. In the exemplary embodiment in FIG. 3, the fire protection cladding 7 also covers the end side 5 which is not equipped with thermal pressure relief valves.

In addition, the fire protection cladding 7 has a respective cutout 8 at two predetermined positions, such that the fire protection cladding 7 is pierced in the region of the cutouts 8. The cutouts 8 are arranged mirror-symmetrically with respect to a longitudinal central plane of the tank container 1 in each case at the lateral edge of the tank container 1, specifically at that end of the tank container 1 which lies opposite the end face 5 equipped with the thermal pressure relief valves.

In the embodiment in FIG. 3, a bottom side of the tank 1 is also provided with the fire protection cladding 7.

It should be emphasized that the fire protection cladding 7 can readily be of multipart design, i.e. is composed from multiple individual plate-like elements.

1-9. (canceled)

10. A tank for flammable liquids and gases for use as a fuel reservoir of a vehicle, the tank comprising:
a tank container equipped with a plurality of thermal pressure relief valves for a possible case of fire, said tank container having an outer side equipped with fire protection cladding being adapted in terms of its contour to an enveloping surface of said tank container.

11. The tank according to claim 10, wherein said fire protection cladding is formed from steel or aluminum plates which are equipped with a fire protection coating or temperature-resistant thermal insulation materials and have a predefined fire resistance.

12. The tank according to claim 10, wherein said fire protection cladding is formed from glass-fiber-reinforced plastics plates which have a predefined fire resistance.

13. The tank according to claim 10, further comprising a tank outlet valve, at least one of said thermal pressure relief valves is integrated into said tank outlet valve.

14. The tank according to claim 10, wherein said tank container has a rectangular base, two mutually opposite end sides, and a middle part, disposed between said end sides, said middle part is free from said thermal pressure relief valves and said middle part of said tank container is occupied exclusively by said fire protection cladding.

15. The tank according to claim 10, wherein said fire protection cladding has a cutout formed therein at at least one predetermined position, and one of said thermal pressure relief valves is disposed at the at least one predetermined position.

16. The tank according to claim 15, wherein:
said tank container has a rectangular base and two mutually opposite end sides, wherein one of said mutually opposite end sides of said tank container is free from said thermal pressure relief valves and occupied by said fire protection cladding, said tank container further having a middle part, disposed between said end sides, and is occupied by said fire protection cladding; and
in said middle part, one of said thermal pressure relief valves is disposed in said cutout in said fire protection cladding.

17. The tank according to claim 15, wherein the at least one predetermined position of said cutout is determined by fire simulation calculations.

18. The tank according to claim 10, wherein said tank container is of multipart construction and has a plurality of tank cylinders of identical length which are disposed parallel to one another and said tank cylinders having end sides which are disposed in a common plane.
